(19) United States
(12) Patent Application Publication
(10) Pub. No.: US 2007/0213051 A1
(43) Pub. Date: Sep. 13, 2007

(54) METHOD OF LOCATION IN AN IMS TYPE NETWORK

(75) Inventors: Olivier Durecu, Marcoussis (FR); Claire Bazin, Paris (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/616,928

(22) Filed: Dec. 28, 2006

(30) Foreign Application Priority Data
Dec. 29, 2005 (FR) 0554128

(51) Int. Cl. H04Q 7/20

(52) U.S. Cl. 455/435.1

(57) ABSTRACT

The invention relates to a method of locating a user in an IMS type network to which said user can make a connection via a plurality of terminals, said method providing for inserting information at the level of the network P-CSCF function, which information relates to the type of access used by the user making a connection with a terminal, and integrating in said network, location means suitable for storing firstly the P-CSCF information relating to the type of access and secondly the public identity IMPU and the IP address of the user on the basis of the S-CSCF function of said network, whereby said means is suitable for directing in the network a location request to the appropriate location information.

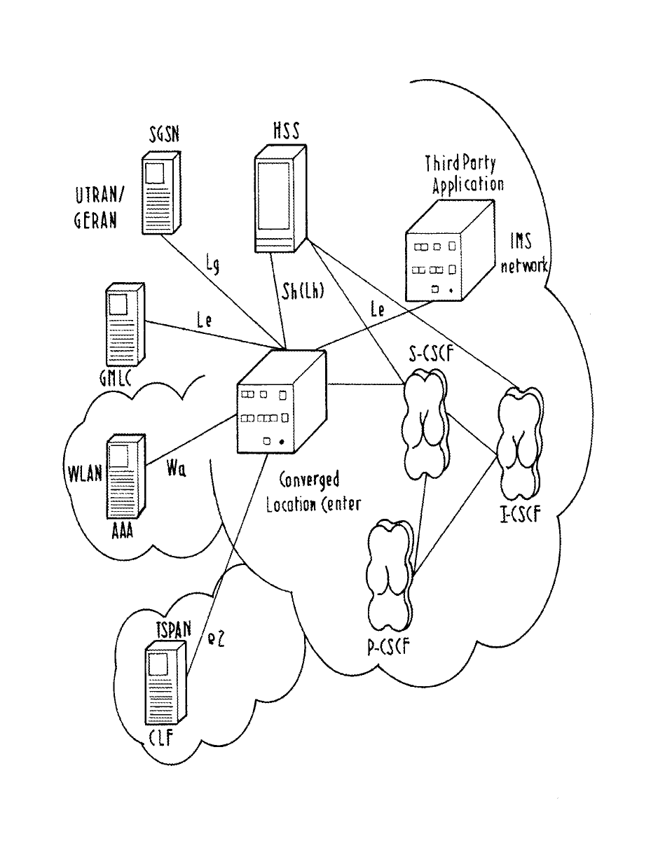

The invention relates to a method of locating a user in an IMS type network to which said user can make a connection via a plurality of terminals, and also to an IMS type network having various types of access to said network by means of terminals.

Development in telecommunications has enabled an increasing number of users to have one or more terminals such as mobile telephones, computers, or personal digital assistants (PDAs) that can communicate via one or more communications networks of different kinds, i.e. using distinct communications protocols.

To enable communication to take place between networks operating under different protocols, a standardized architecture known as Internet protocol multimedia subsystem (IMS) has been developed under the 3GPP standard.

An IMS network uses a protocol known as Internet protocol (IP) enabling it in particular to convey information in the form of packets, each packet having a header giving an IP address for the packet destination, such that packets can follow different paths in order to reach the same destination. IP protocol enables the IMS network to receive or transmit information from different networks associated with the IMS network and encoded using different protocols specific to each network.

In a network of IMS type, a user possesses a plurality of public IMS identities (IMPU) as a function of the terminal via which a connection is made and/or of the identifier used on a given terminal. In particular, a user may be connected to the IMS network equally well via different types of access, whether cellular (identifier in the form of an MSISDN subscriber number), of the WLAN type (identifier in the form of an IP address), or of the fixed type.

Furthermore, an IMS type network may have user location servers that are specific to the type of access used by the user for making a connection. Location in any one type of access, and the way in which this location can be recovered, both depend on the nature of said access.

The problem that arises is that the IMS services of the network that are based on location do not know the type of access that is active for a user, nor do they know the associated identifier, so they cannot recover the location of said user.

An object of the invention is to mitigate that problem by proposing specifically to integrate, in an IMS type network, location means suitable for directing a location request issued by a service to information that is pertinent concerning the location of an active user.

To this end, and in a first aspect, the invention provides a method of locating a user in an IMS type network to which said user can make a connection via a plurality of terminals, said method providing for inserting information at the level of the network P-CSCF function, which information relates to the type of access used by the user making a connection with a terminal, and integrating in said network, location means suitable for storing firstly the P-CSCF information relating to the type of access and secondly the public identity IMPU and the IP address of the user on the basis of the S-CSCF function of said network, whereby said means is suitable for directing in the network a location request to the appropriate location information.

Thus, by benefiting in real time from the type of access used by a registered user, the location means can direct the location request to the location server that corresponds to the pertinent type of access that is being used.

In a second aspect, the invention provides an IMS type network including various types of access to said network by means of terminals, said network including a P-CSCF function suitable for containing information relating to types of access to the network, and location means which, on a user making a connection, is suitable for retrieving firstly information relating to the type of access from the P-CSCF, and secondly the public identity IMPU and the IP address of the user from the S-CSCF, so that said means is suitable for directing a location request to the appropriate location information.

Other features and advantages of the invention appear from the following description of various particular implementations, which description is made in association with the accompanying figure that shows the general architecture of an IMS network in an embodiment of the invention.

The figure represents an IMS network conventionally comprising a plurality of session initiation protocol (SIP) servers referred to overall under the name call session control function (CSCF).

In particular, the proxy-CSCF (P-CSCF) is the first point of contact in the IMS network for a connection terminal. In addition, the interrogating-CSCF (I-CSCF) serves to find the serving-CSCF (S-CSCF) during registration, which in turn takes charge of identifying the user being registered.

In addition, the IMS network includes home subscriber server (HSS) type data storage equipment in communication with the S-CSCF.

Furthermore, the figure also shows, diagrammatically, three connection type entities connected to the IMS network, respective UTRAN/GERAN for a cellular type connection, WLAN for an IP type connection, and TISPAN for a fixed type connection.

For each of these types of access, the figure shows connected user location servers respectively known as: a gateway mobile location center (GMLC); authentication, authorization, and accounting (AAA); and connectivity session location function (CLF); respectively for those type of access in the above-specified order. In addition, each of these servers communicates via corresponding interfaces Lg, Le, Wa, and e2, respectively.

In the invention, the IMS network also has location means referred to as a converged location center and connected to each of the location servers via their respective interfaces, and also connected to the HSS server.

Furthermore, the location means is connected to the S-CSCF so that when a user makes a connection it can recover the public identity IMPU of the user together with the corresponding IP address in the IMS network. In particular, the location means can recover this information during registration, in particular during the third party registration mechanism implemented by the S-CSCF, by making a notification for the information to be extracted from the register message.

Consequently, by providing for the P-CSCF function to be suitable for containing information relating to type of access to the network (UTRAN, GERAN, WLAN, TISPAN), and by storing this information in the location means, it is possible to direct a location request to the location information of the appropriate server by using the location means. In particular, the location means can be suitable for recovering pertinent location information.

In an embodiment, the location means may be integrated in an existing server, in particular in the GMLC which have most of the interfaces needed for implementation thereof.

There follows a description of several implementations of a method of locating a user in such an IMS network.

The method makes provision for inserting information at the level of the P-CSCF function of the network, which information relates to the type of access being used by the user on making a connection with a terminal.

In addition, the method makes provision for integrating location means in said network, which means is suitable for storing firstly the information from the P-CSCF relating to the type of access, and secondly the public identity IMPU and the IP address of the user from the S-CSCF function of said network.

Thus, the location means is suitable for directing a location request in the network to appropriate location information, i.e. the location of the server corresponding to the type of access used by the user to make the connection.

In an implementation, the location means activate the interface Sh of the network with the HSS server of said network in order to locate a user connected via a mobile station ISDN number (MSISDN) access by using the user's public identity IMPU. Thus, the MSISDN of a user connected to a UTRAN/GERAN access network is recovered from the user's IMPU.

In another implementation, the location means activate the interface Le in the event of a request to locate a third party application so as to offer a standardized interface for said request.

The method may also provide for the location means to activate the location server interface of the various accesses to the network, so as to request the location of the user therefrom. In particular, the interface Lf to the HSS, the interface Le to the GMLC, the interface Lg to the SGSN, the interface e2 to the TISPAN CLF, and the interface Wa to the WLAN AAA can be used.

In the invention, a third party application can thus request the location of a user on the basis of the user's identity in the IMS network. The location means can thus associate said identity with an IP address or with an MSISDN number, and can request the location server associated with the appropriate network access to locate the user.

Thus, solely on the basis of a user's IMS identity, the operator of the IMS network can recover the most appropriate location without knowing a priori what kind of access the user is using for the connection nor the identifier with which the user is connected.

1. A method of locating a user in an IMS type network to which said user can make a connection via a plurality of terminals, said method providing for inserting information at the level of the network P-CSCF function, which information relates to the type of access used by the user making a connection with a terminal, and integrating in said network, location means suitable for storing firstly the P-CSCF information relating to the type of access and secondly the public identity IMPU and the IP address of the user on the basis of the S-CSCF function of said network, whereby said means is suitable for directing in the network a location request to the appropriate location information.

2. A location method according to claim 1, in which the location means activate the interface Sh of the network to information storage equipment (HSS) of said network in order to locate a user connected by an MSISDN access on the basis of the user's public identity IMPU.

3. A location method according to claim 1, in which the location means activate the interface Le in the event of a location request from a third party application.

4. A location method according to claim 1, in which the location means activate the interface of the location server of the various accesses to the network so as to request the user location therefrom.

5. An IMS type network including various types of access to said network by means of terminals, said network including a P-CSCF function suitable for containing information relating to types of access to the network, and location means which, on a user making a connection, is suitable for retrieving firstly information relating to the type of access from the P-CSCF, and secondly the public identity IMPU and the IP address of the user from the S-CSCF, so that said means is suitable for directing a location request to the appropriate location information.

6. An IMS type network according to claim 5, characterized in that the location means is integrated in the GMLC of said network.
